(19) United States
(12) Patent Application Publication
(10) Pub. No.: US 2025/0306361 A1
(43) Pub. Date: Oct. 2, 2025

(54) WAVEGUIDE WITH EXIT PUPIL EXPANDER AND OUTCOUPLER ON SEPARATE SUBSTRATES

(71) Applicant: GOOGLE LLC, Mountain View, CA (US)

(72) Inventors: Daniel Adema, Kitchener (CA); Shreyas Potnis, Kitchener (CA)

(21) Appl. No.: 18/864,363

(22) PCT Filed: May 9, 2023
(86) PCT No.: PCT/US2023/021503

§ 371 Date: Nov. 8, 2024

Related U.S. Application Data
(60) Provisional application No. 63/342,779, filed on May 17, 2022.

(51) Int. Cl. G02B 27/00; G02B 6/26; G02B 6/34; G02B 27/01; G02B 27/28

(52) U.S. Cl. CPC G02B 27/0081; G02B 6/262; G02B 6/34; G02B 27/0172; G02B 27/283; G02B 2027/0123; G02B 2027/0178

(57) ABSTRACT

A waveguide includes a first substrate including an exit pupil expander and a second, separate substrate including an outcoupler. The first substrate and the second substrate overlap one another and are separated by a partition element. One or more facets direct light from the first substrate after exit pupil expansion toward the second substrate so that the light can be outcoupled by the outcoupler.

### BACKGROUND

In an augment reality (AR) or mixed reality (MR) eyewear display, light from an image source is coupled into a light guide substrate, generally referred to as a waveguide or a lightguide, by an input optical coupling (i.e., an “incoupler) which can be formed on a surface of the substrate or disposed within the substrate. Once the light beams have been coupled into the waveguide, the light beams are “guided” through the substrate, typically by multiple instances of total internal reflection (TIR), to then be directed out of the waveguide by an output optical coupling (i.e., an “outcoupler”). In some cases, another optical component known as an exit pupil expander is positioned in the optical path between the incoupler and the outcoupler to expand the light beams in at least one dimension. The light beams projected from the waveguide by the outcoupler overlap at an eye relief distance from the waveguide forming an exit pupil within which a virtual image generated by the image source can be viewed by the user of the eyewear display.

### SUMMARY

In a first embodiment, a waveguide includes a first substrate including an exit pupil expander. The waveguide also includes a second substrate overlapping the first substrate, the second substrate including an outcoupler.

In some aspects of the first embodiment, the waveguide includes one or more facets to direct light from the first substrate to the second substrate. In some aspects of the first embodiment, the one or more facets comprise reflective facets comprising a mirror coating. In some aspects of the first embodiment, the one or more facets comprise diffractive or holographic gratings. In some aspects of the first embodiment, the waveguide includes a partition element between the first substrate and the second substrate. In some aspects of the first embodiment, the partition element comprises a lower-refractive index than the first substrate and the second substrate. In some aspects of the first embodiment, the partition element includes an airgap. In some aspects of the first embodiment, the partition element includes a solid material. In some aspects of the first embodiment, the partition element includes a polarization beam splitter. In some aspects of the first embodiment, the exit pupil expander expands light in a first direction and the outcoupler outcouples light from the waveguide in a second direction different from the first direction. In some aspects of the first embodiment, the first direction is orthogonal to the second direction. In some aspects of the first embodiment, the first substrate overlaps the second substrate when viewed from a direction at which the outcoupler outcouples light out of the waveguide.

In a second embodiment, an optical combiner includes a first lens layer and a second lens layer with a waveguide disposed between the first lens layer and the second lens layer. The waveguide includes a first substrate including an exit pupil expander. The waveguide also includes a second substrate overlapping the first substrate, the second substrate including an outcoupler.

In some aspects of the second embodiment, the waveguide includes one or more facets to direct light from the first substrate to the second substrate. In some aspects of the second embodiment, the waveguide includes a partition element disposed between the first substrate and the second substrate. In some aspects of the second embodiment, the partition element includes a lower-refractive index than the first substrate and the second substrate. In some aspects of the second embodiment, the partition element includes a polarization beam splitter.

In a third embodiment, an eyewear display includes one or more lenses including an optical combiner. The optical combiner includes a waveguide. The waveguide includes a first substrate including an exit pupil expander. The waveguide also includes a second substrate overlapping the first substrate, the second substrate including an outcoupler.

In some aspects of the third embodiment, the optical combiner includes a first lens layer and a second lens layer, wherein the waveguide is disposed between the first lens layer and the second lens layer. In some aspects of the third embodiment, the waveguide includes one or more facets to direct light from the first substrate to the second substrate, and a partition element between the first substrate and the second substrate. In some aspects of the third embodiment, the partition element comprises a lower-refractive index than the first substrate and the second substrate. In some aspects of the third embodiment, the eyewear display includes a frame to hold the one or more lenses.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example eyewear display, in accordance with some embodiments.

FIG. 2 illustrates an example diagram of a projection system that projects display light representing images onto the eye of a user via an eyewear display, such as the eyewear display of FIG. 1, in accordance with some embodiments.

FIG. 3 shows an example of a portion of an eyewear display with a limited field of view (FOV) area as identified in the present disclosure.

FIGS. 4 and 5 illustrate issues of expanding the FOV area according to conventional techniques as identified in the present disclosure.

FIG. 6 shows an expanded view of a waveguide with an exit pupil expander (EPE) and an outcoupler on different substrates, in accordance with some embodiments.

FIGS. 7-9 show examples of waveguides with different partition elements positioned between a first substrate with an EPE and a second substrate with an outcoupler, in accordance with some embodiments.

FIG. 10 shows an example of an optical combiner with a waveguide, such as one illustrated in FIGS. 7-9, between two lens layers, in accordance with some embodiments.

### DETAILED DESCRIPTION

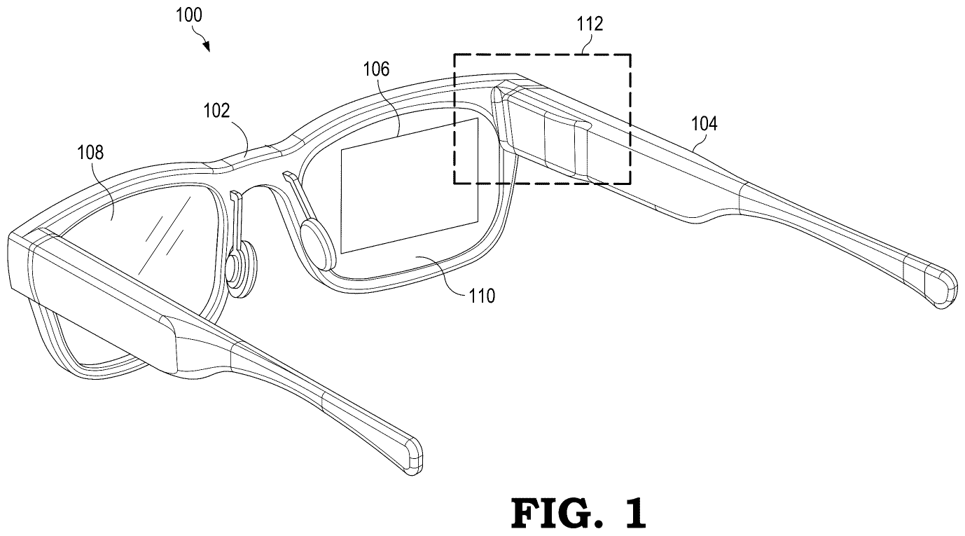

Lenses in an AR/MR eyewear display with an eyeglass frame form factor typically have a relatively small field of view (FOV) area for projecting images generated by the image source of the eyewear display. For example, in conventional eyewear displays of this type, the FOV area is normally on the scale of about 10° by 10° in the horizontal and vertical directions. In some cases, it may be advantageous to increase the size of the FOV area so the user is able to perceive images over a larger area of the lens of the eyewear display. Expanding the FOV area generally involves increasing the size of the outcoupler and the size of the corresponding exit pupil expander (EPE) in the waveguide. However, due to the limited space available in a conventional waveguide, increasing the size of both the EPE and the outcoupler in the waveguide using conventional techniques is not practicable since it would lead to significant interference between the two components. For instance, expanding the size of the EPE in the waveguide substrate would reduce the space available in the waveguide substrate to expand the outcoupler. FIGS. 1-10 present techniques to increase the FOV area in an eyewear display by implementing the EPE and the OC on separate substrates of a waveguide. Therefore, each of the EPE and the OC can be expanded without interfering with one another.

To illustrate, in some embodiments, the waveguide includes an incoupler and an EPE on a first substrate and an outcoupler on a second substrate. In some embodiments, the first substrate and the second substrate are included in a stack of overlapping layers. The waveguide also includes a partition element or layer positioned between the first and the second substrates and a set of reflective facets to direct light from the first substrate to the second substrate through or around the partition element. The partition element ensures that light propagating in the EPE in the first substrate does not interfere with light propagating at the outcoupler in the second substrate and vice versa. The set of reflective facets is positioned to direct light, after it has passed through the EPE, from the first substrate to the second substrate so that the light can also pass through the outcoupler. In some embodiments, the partition element includes a material with a lower-refractive index than the refractive index of the material in the first and the second substrates. By placing the EPE and the outcoupler onto different, overlapping substrates, both the EPE and the outcoupler can be expanded in a waveguide without interfering with one another. Accordingly, the size of the FOV area of the eyewear display can be increased, thereby allowing the user to view generated images over a larger display region of the eyewear display.

FIGS. 1-10 show devices and techniques to increase the FOV area, thus increasing the virtual image display area, of an eyewear display as described in greater detail below. While the disclosed devices and techniques are described with respect to an example display system, it will be appreciated that present disclosure is not limited to implementation in this particular display system, but instead may be implemented in any of a variety of display systems using the guidelines provided herein.

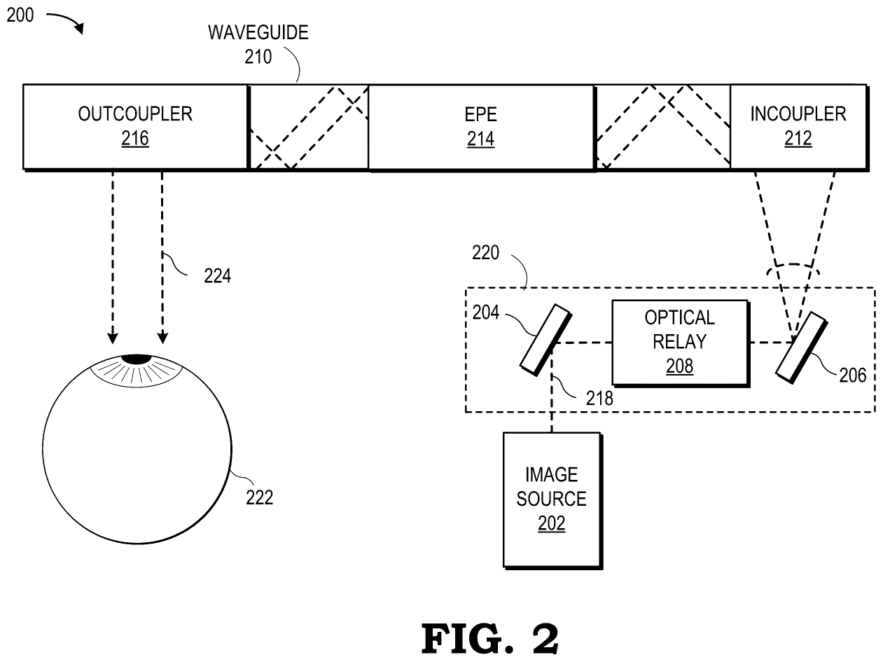

FIG. 1 illustrates an example eyewear display 100 in accordance with various embodiments. The eyewear display 100 (also referred to as a wearable heads up display (WHUD), head-mounted display (HMD), near-eye display, or the like) has a support structure 102 that includes an arm 104, which houses a micro-display projection system configured to project images toward the eye of a user, such that the user perceives the projected images as being displayed in a field of view (FOV) area 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images toward the eye of the user, such as an image source (also referred to as light engine, optical engine, projector, or the like) and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. The support structure 102, in some embodiments, further includes processing circuitry or control circuitry to carry out functions of the eyewear display 100 such as eye tracking functions, for example. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in a temple region 112 of the support structure 102 or in a nose bridge region 114 of the support structure 102. It should be noted that while an example form factor is depicted, it will be appreciated that in other embodiments the eyewear display 100 may have a different shape and appearance from the eyeglasses frame depicted in FIG. 1.

One or both of the lens elements 108, 110 are used by the eyewear display 100 to provide an AR or MR display in which rendered graphical content can be superimposed over or otherwise provided in conjunction with a real-world view as perceived by the user through the lens elements 108, 110. In some embodiments, one or both of lens elements 108, 110 includes a first lens layer and a second lens layer with a waveguide disposed therebetween. In some embodiments, one or both of lens elements 108, 110 serve as optical combiners that combine environmental light (also referred to as ambient light) from outside of the eyewear display 100 and light emitted from an image source in the eyewear display 100. For example, light used to form a perceptible image or series of images may be projected by the image source of the eyewear display 100 onto the eye of the user via a series of optical elements, such as a waveguide formed at least partially in the corresponding lens element, one or more scan mirrors, one or more optical relays, and/or one or more prisms. In some embodiments, multiple image sources are included in the support structure 102. In some cases, the multiple image sources are located in the temple region 112, in the nose bridge region, or in a combination of the two regions (e.g., one image source in the temple region 112 and another image source in the nose bridge region). In some embodiments, the waveguide includes a layered stack with a first substrate including an incoupler and an EPE and a second substrate including an outcoupler. In some embodiments, a partition element is located between the two substrates to ensure that TIR conditions are maintained for light propagating in each of the two substrates. Additionally, a set of facets is included at or near one end of both of the substrates to direct light (e.g., via reflection) from the first substrate, after it has passed through the EPE, to the second substrate so that the light can then be directed toward the outcoupler. One or both of the lens elements 108, 110 thus includes at least a portion of a waveguide that routes display light received by an incoupler of the waveguide through an EPE and to the outcoupler of the waveguide, which outputs the display light toward an eye of a user of the eyewear display 100. The display light is modulated and projected onto the eye of the user such that the user perceives the display light as an image in the FOV area 106. In addition, each of the lens elements 108, 110 is sufficiently transparent to allow a user to see through the lens elements to provide a field of view of the user's real-world environment such that the image appears superimposed over at least a portion of the real-world environment.

In some embodiments, each of the one or more image sources is a matrix-based projector, a scanning laser projector, or any combination of a modulative light source such as a laser or one or more LEDs and a dynamic reflector mechanism such as one or more dynamic scanners or digital light processors. In some embodiments, the image source includes multiple laser diodes (e.g., a red laser diode, a green laser diode, and/or a blue laser diode) and at least one scan mirror (e.g., two one-dimensional scan mirrors, which is a micro-electromechanical system (MEMS)-based or piezo-based), for example. The image source is communicatively coupled to a controller and a non-transitory processor-readable storage medium or memory storing processor-executable instructions and other data that, when executed by the controller, cause the controller to control the operation of the image source. In some embodiments, the controller controls a scan area size and scan area location for the image source and is communicatively coupled to a processor (not shown) that generates content to be displayed at the eyewear display 100. The image source scans light over a variable area, designated the FOV area 106, of the eyewear display 100. The scan area size corresponds to the size of the FOV area 106 and the scan area location corresponds to a region of one of the lens elements 108, 110 at which the FOV area 106 is visible to the user. Generally, it is desirable for a display to have a wide FOV area to accommodate the outcoupling of light across a wide range of angles. Herein, the range of different user eye positions that will be able to see the display is referred to as the eyebox of the eyewear display 100.

The techniques and apparatuses described herein increase the FOV area 106 of a waveguide within the form factor limitations imposed by the eyewear display 100. In some embodiments, a waveguide incorporated in one or in each of lens elements 108, 110 is made of a stack of layers including two separate substrate layers. The incoupler and the EPE are embedded in or on the first of the two substrate layers and the outcoupler is embedded in or on the second of the two substrate layers. By positioning the EPE and the outcoupler on different substrate layers, each of the EPE and the outcoupler can be enlarged without reducing the space to potentially enlarge the other. In this manner, the overall FOV area 106 can be increased. This results in increasing the area over which images generated by the eyewear display 100 can be displayed to the user.

FIG. 2 illustrates a diagram of a projection system 200 that projects display light representing images onto the eye 222 of a user via a waveguide 210 in an eyewear display, such as eyewear display 100 illustrated in FIG. 1. The projection system 200 includes an image source 202, an optical scanner 220, and the waveguide 210. One image source 202 and corresponding optical scanner 220 are illustrated in FIG. 2 for clarity purposes, but in some embodiments, multiple image sources 202 and optical scanners 220 are included in projection system 200.

In some embodiments, the image source 202 includes one or more laser light sources configured to generate and output laser light (e.g., visible laser light such as red, blue, and green laser light and/or non-visible laser light such as infrared laser light). In some embodiments, the image source 202 is coupled to a controller or driver (not shown), which controls the timing of emission of display light from the light sources of the image source 202 (e.g., in accordance with instructions received by the controller or driver from a computer processor coupled thereto) to modulate the display light 218 to be perceived as images when output to the retina of the eye 222 of the user.

In some embodiments, the optical scanner 220 includes a first scan mirror 204, a second scan mirror 206, and an optical relay 208. In some cases, one or both of the scan mirrors 204 and 206 are MEMS mirrors. For example, the scan mirror 204 and the scan mirror 206 are MEMS mirrors that are driven by respective actuation voltages to oscillate during active operation of the laser projection system 200, causing the scan mirrors 204 and 206 to scan the display light 218 toward an incoupler 212 of the waveguide 210.

The waveguide 210 of the projection system 200 includes an incoupler 212, an EPE 214, and an outcoupler 216. The term “waveguide,” as used herein, will be understood to mean a combiner using total internal reflection (TIR), or via a combination of TIR, specialized filters, and/or reflective surfaces, to transfer light from an incoupler, through the EPE, and to a corresponding outcoupler. For display applications, the light is representative of a collimated image, for example, and the waveguide transfers and replicates the collimated image to the eye. In general, the terms “incoupler,” “exit pupil expander” (or “EPE” for short), and “outcoupler” will be understood to refer to any type of optical grating structure, including, but not limited to, diffraction gratings, slanted gratings, blazed gratings, holograms, holographic optical elements (e.g., optical elements using one or more holograms), volume diffraction gratings, volume holograms, surface relief diffraction gratings, and/or surface relief holograms. In some embodiments, a given incoupler, EPE, or outcoupler is configured as a transmissive diffraction grating that causes the incoupler, EPE, or outcoupler to transmit light and to apply designed optical function(s) to the light during the transmission. In some embodiments, a given incoupler, EPE, or outcoupler is a reflective diffraction grating that causes the incoupler, EPE, or outcoupler to reflect light and to apply designed optical function(s) to the light during the reflection. In the present example, the display light 218 received at the incoupler 212 is relayed to EPE 214 which expands the light in one dimension (e.g., into or out of the page as illustrated in FIG. 2) and directs the light to the outcoupler 216 via TIR within the waveguide 210. The display light is then output to the eye 222 of a user via the outcoupler 216 as light 224 (one beam labeled for clarity).

In some embodiments, the EPE 214 receives light from the incoupler 212 and expands the light in one dimension in the eyebox of an eyewear display (such as one corresponding to eyewear display 100) housing the projection system 200. In some embodiments, the EPE 214 includes one-dimensional diffractive gratings to expand the light in this manner. After expanding the light in one dimension, the EPE 214 forwards the light to the outcoupler 216. After receiving the light from the EPE 214, the outcoupler 216 expands the light in a second dimension and outcouples the light 224 to the eye 222 of the user. Accordingly, in some embodiments, the size of the outcoupler 216 corresponds to an area over which the user can perceive images generated by the image source 202. In other words, the size of the outcoupler 216 corresponds to the size of the FOV area of an eyewear display with projection system 200 (such as FOV area 106 illustrated in FIG. 1).

FIG. 2 illustrates the optical components of the waveguide 210, i.e., the incoupler 212, the EPE 214, and the outcoupler 216, in order from right to left to illustrate the path of propagation of light within the waveguide for clarity purposes of the explanation. In some embodiments, the configuration of the incoupler 212, the EPE 214, and the outcoupler 216 is different from that shown in FIG. 2. For example, in some embodiments, the waveguide 210 is composed of a layered stack with the incoupler 212 and the EPE 214 on a first substrate of the layered stack and the outcoupler 216 on a second substrate of the layered stack. In some embodiments, the waveguide 210 also includes a partition element (not shown in FIG. 2) between the first substrate and the second substrate and a set of reflective facets (not shown in FIG. 2) to direct light from the first substrate to the second substrate.

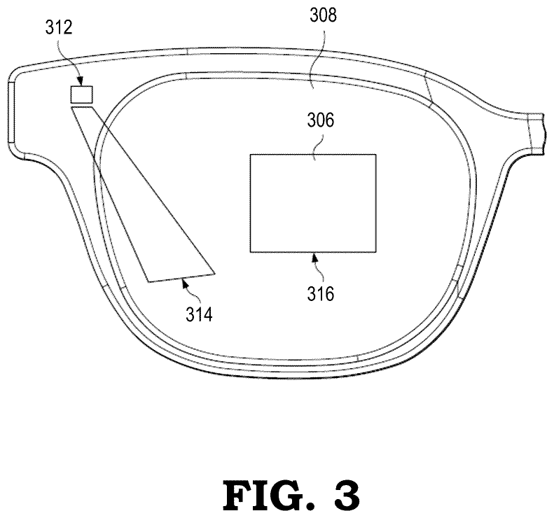

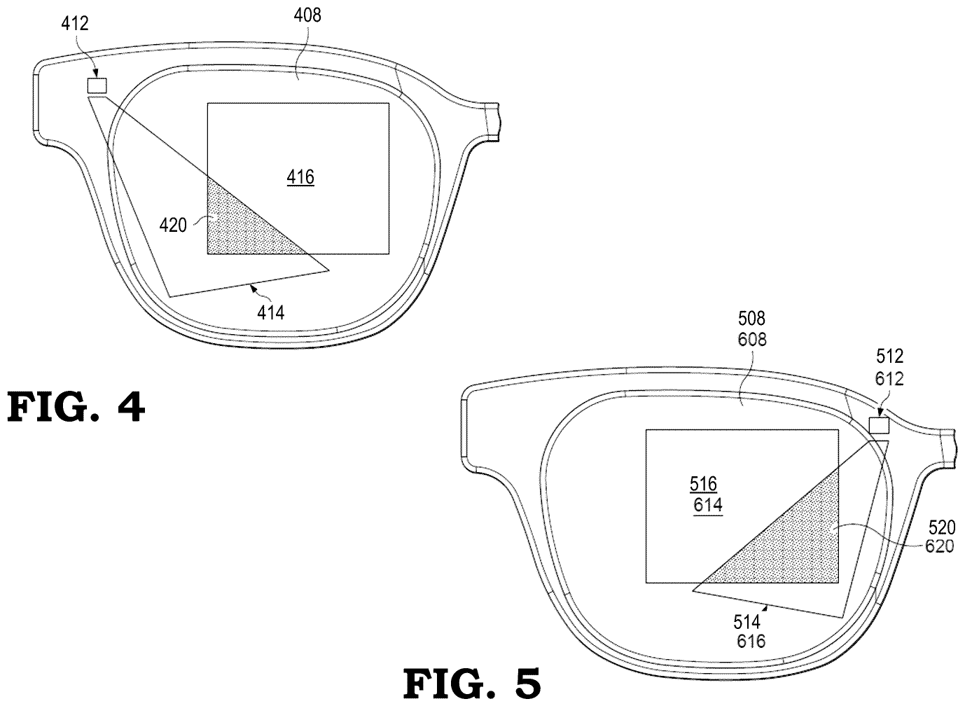

FIG. 3 shows an example of a portion of an eyewear display 300 having an eyeglass frame form factor with a limited FOV 306 as identified in accordance with some embodiments. For example, the FOV 306 is in the range of about 10°×10° in the horizontal and vertical directions since there is limited space available in the lens 308 to incorporate a conventional waveguide. As illustrated in FIG. 3, the components of the waveguide include an incoupler 312, an EPE 314, and an outcoupler 316. In FIG. 3, the incoupler 312 is located in the temple region of the support structure of the eyewear display 300. The EPE 314 is located partially in the temple region and partially in the lens 308 while the outcoupler 316 is located entirely in the lens 308 and corresponds to the FOV area 306. Thus, increasing the FOV area 306 involves increasing the size of the outcoupler 316, which also requires expanding the size of the EPE 314. However, due to the limited space available in the lens 308, increasing the sizes of the EPE 314 and the outcoupler 316 according to conventional techniques is generally not possible due to the issues illustrated in FIGS. 4 and 5.

FIGS. 4 and 5 illustrate issues when expanding the FOV area according to conventional techniques. FIG. 4 shows an example where the incoupler 412 is located in the temple region of the support structure. FIG. 5 shows an example where the incoupler 512 is located in the nose bridge region of the support structure. In either case, a larger outcoupler (outcoupler 416 and outcoupler 516 in FIGS. 4 and 5, respectively) and a larger EPE (EPE 414 and EPE 514 in FIGS. 4 and 5, respectively) are needed to provide a larger FOV area in each of the respective lenses 408, 508. However, increasing the sizes of the outcoupler and EPE leads to significant interference 420 and 520 between the two in a waveguide substrate as shown in FIGS. 4 and 5, respectively. These interferences 420 and 520 lead to conflict between the function of the EPE (i.e., expanding the display light in a first dimension) and the function of the outcoupler (i.e., expanding the display light in a second dimension different from the first dimension and outcoupling the light to the user) that cannot be resolved by trimming either or both of the EPE or the outcoupler without negatively impacting the quality of the image delivered to the user. Thus, conventional techniques to increase the FOV area of a waveguide are severely limited by the form factor of the lens and/or the eyeglass frame in this type of eyeglass display.

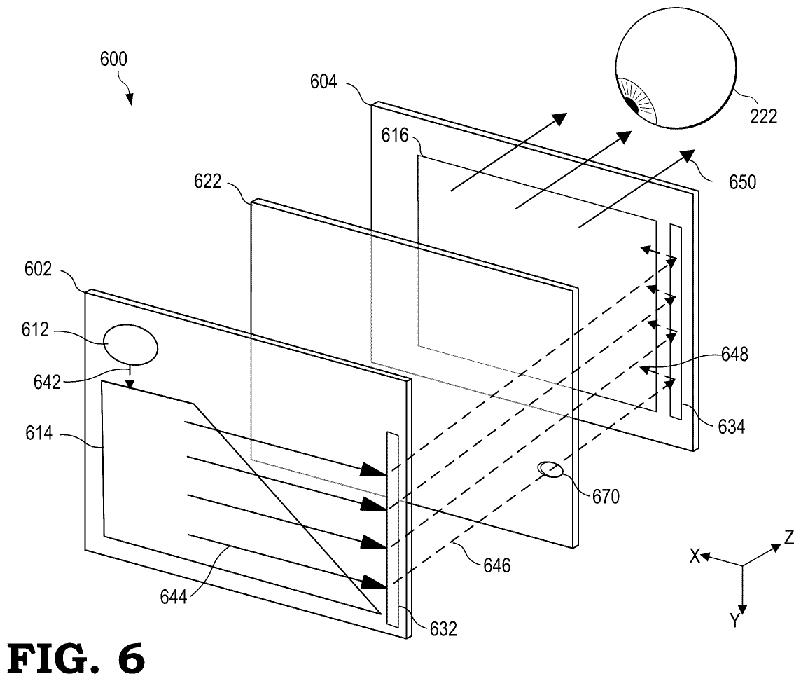

FIG. 6 shows an expanded view of a waveguide 600 in accordance with various embodiments. The waveguide 600 includes a stack of components or layers including a first substrate 602 and a second substrate 604. In some embodiments, the waveguide 600 also includes a partition element 622.

In some embodiments, the first substrate 602 and the second substrate 604 are made of the same material. For example, in some embodiments, each of the first substrate 602 and the second substrate 604 are made of a transparent or semi-transparent material (e.g., plastics, polymers, glass, or the like) with optical characteristics to enable the functionality of an AR/MR eyewear display. In other embodiments, the first substrate 602 and the second substrate 604 are made of different waveguide materials. The first substrate 602 includes an incoupler 612 and an EPE 614 (such as the incoupler or the EPE described in the preceding Figures), and the second substrate 604 includes an outcoupler 616 (such as the outcoupler described in the preceding Figures). As illustrated, the first substrate 602 and the second substrate 604 overlap one another. For example, the first substrate 602 and the second substrate 604 are included in a stack of components that make up the waveguide 600 that overlap one another in the z-direction shown in FIG. 6. In some embodiments, the term “overlap” with respect to the first substrate and the second substrate means that at least 50% of the first substrate is coincident with the second substrate (or vice versa) along at least one axis (e.g., the z-direction) as shown in FIG. 6. That is, when viewed from a user-side (i.e., from the viewpoint of the eye 222 of the user), at least 50% of the second substrate 604 overlaps the first substrate 602, or when viewed from the world-side (i.e., from the opposite side of the waveguide as the eye 222 of the user), at least 50% of the first substrate 602 overlaps the second substrate 604. In some embodiments, the term “overlap” with respect to the EPE 614 and the outcoupler 616 means that each of these optical components (i.e., the EPE and the outcoupler) are performing their respective optical functions (e.g., with respect to the EPE, expanding the light beams along one dimension) on separate but adjacent planes. For example, referring to the waveguide 600 illustrated in FIG. 6, the EPE 614 is expanding the light beams in a plane corresponding to first substrate 602, and the outcoupler 616 is expanding the light beams in a separate but adjacent plane corresponding to second substrate 604. In some embodiments, to facilitate the manufacturing of the waveguide 600, the first substrate 602 and the second substrate 604 are entirely or mostly coincident with one another, i.e., the first substrate and the second substrate completely or nearly completely overlap one another, e.g., 90% or more. In some embodiments, the dimensions of the first substrate 602 and the second substrate 604 are essentially the same and both substrates overlap one another completely so as to avoid the appearance of an edge, e.g., as observed by a user.

In some embodiments, the waveguide 600 includes a partition element 622 between the first substrate 602 and the second substrate 604. In some embodiments, the partition element is an air gap (or other gas-filled gap), a low-refractive index material (i.e., a material with a lower refractive index compared to the refractive indices of the material(s) of the first substrate 602 and the second substrate 604), or a polarization beam splitter (PBS). In any case, the partition element 622 acts as a barrier so that light propagating in the EPE 614 and light propagating in the outcoupler 616 do not interfere with one another. For example, light in the EPE 614 propagates in the EPE 614 via TIR when incident on the partition element 622 from the first substrate 602 side, and light in the outcoupler 616 propagates in the outcoupler 616 via TIR when incident on the partition element 622 from the second substrate 604 side. Thus, in some embodiments, the interface between the first substrate 602 and the partition element 622 and the interface between the second substrate 604 and the partition element 622 enable TIR conditions for light in the first substrate 602 and light in the second substrate 604, respectively.

In some embodiments, the waveguide 600 also includes a set of facets 632 634. For example, a first facet 632 is located in the first substrate 602 and a second facet 634 is located in the second substrate 604. The set of facets 632, 634 directs light from the first substrate 602 to the second substrate 604. For example, after the light has passed through the EPE 616 and been expanded in a first dimension/direction (e.g., along the y-dimension in FIG. 6), facet 632 directs light from the first substrate 602 through or around the partition element 622 to facet 634. In some embodiments, the partition element 622 includes one or more holes or openings 670 that allows light to pass from the first facet 632 to the second facet 634. In some embodiments, facet 632 is positioned such that light incident thereon breaks TIR conditions in the first substrate 602, exits the first substrate 602, and is incident on facet 634. Facet 634 directs the light incident thereon within the second substrate 604 via TIR toward the outcoupler 616 to be expanded in a second dimension/direction (e.g., along the x-dimension in FIG. 6) and be outcoupled to the eye 222 of the user. In some embodiments, the set of facets 632, 634 are any type of reflective surface such as a mirror or a metallic layer. In some embodiments, the set of facets 632, 634 include facets coated with a mirror coating or facets coated with a Bragg mirror coating. In other embodiments, the set of facets 632, 634 are diffractive gratings or holographic gratings.

By separating the EPE 614 and the outcoupler 616 onto different substrates in this manner, waveguide 600 allows for the EPE 614 and the outcoupler 616 to be expanded without interfering with one another. This results in an expanded FOV area, thereby allowing an eyewear display with waveguide 600 to provide generated images (e.g., from an image source such as image source 202) over a larger display area.

In some embodiments, light is routed through waveguide 600 according to the following path. First, the light is incoupled at the incoupler 612 and directed within the first substrate 602 via TIR as incoupled light 642 toward the EPE 614. The EPE 614 expands the display light in a first dimension (e.g., along the y-direction in FIG. 6) as EPE light 644 (one arrow labeled for clarity purposes). This light propagates through the EPE 614 via TIR with the partition element 622 on one side and the external surface (the near side in FIG. 6) of the first substrate 602 on the other side. Upon reaching the first facet 632, the light is directed out of the first substrate 602 as inter-substrate light 646 (one dashed arrow labeled for clarity purposes). The inter-substrate light 646 passes through or is directed around the partition element 622 and is incident on the second facet 634 in the second substrate 604. The second facet 634 directs the light incident thereon within the second substrate as second substrate light 648 (one arrow labeled for clarity purposes) via TIR with the second substrate external surface (far side in FIG. 6 facing the eye 222 of the user) and the partition element 622. The second substrate light 648 is directed toward the outcoupler 616, which expands the light in another dimension/direction and outcouples the light as outcoupled light 650 toward the eye 222 of the user.

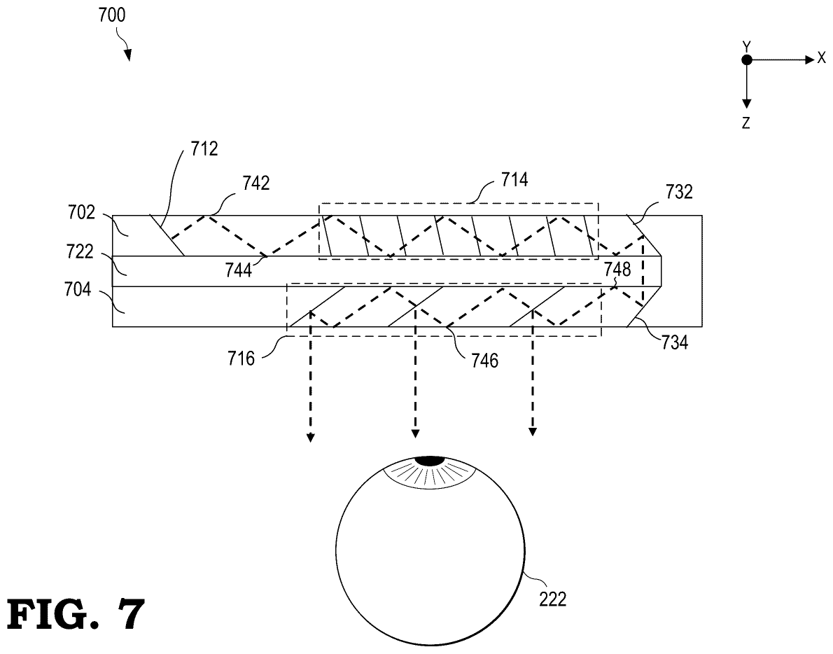

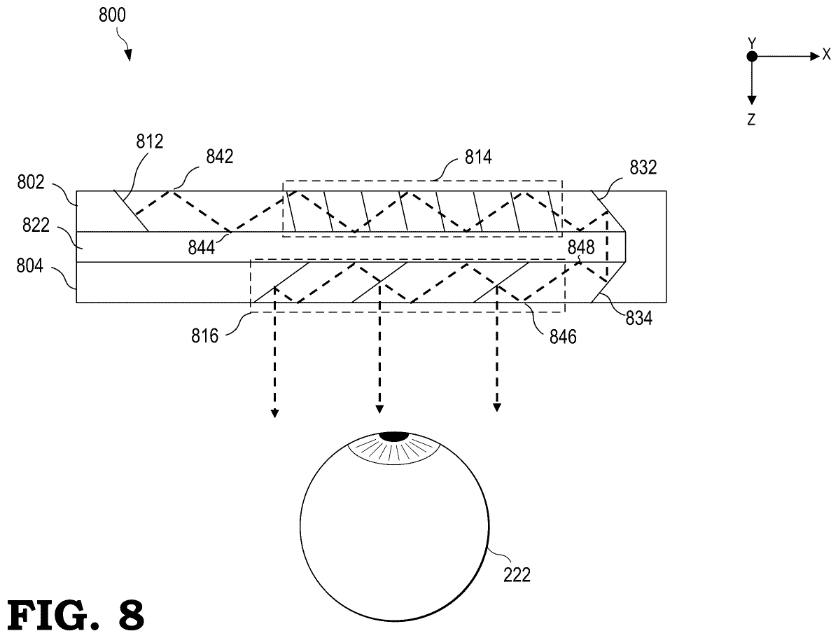

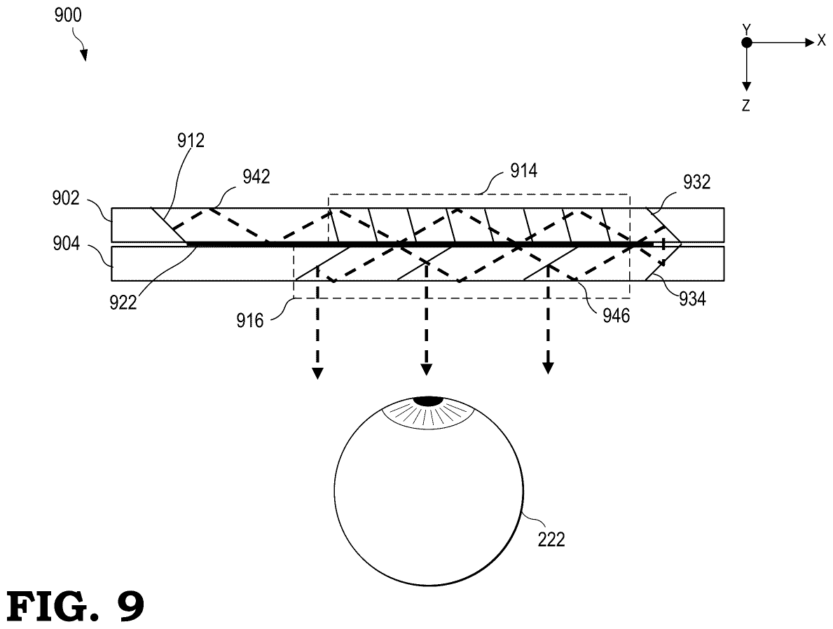

FIGS. 7-9 show different embodiments of a waveguide, such as waveguide 600, with different types of partition elements positioned between the two substrates in accordance with various embodiments. The paths of light propagation within and out of the waveguides in FIGS. 7-9 are indicated by dashed lines. As shown in FIGS. 7-9, the first substrate in each Figure (e.g., first substrate 702 in FIG. 7, first substrate 802 in FIG. 8, and first substrate 902 in FIG. 9) overlaps the second substrate in each Figure (e.g., second substrate 704 in FIG. 7, second substrate 804 in FIG. 8, and second substrate 904 in FIG. 9). In this manner, each corresponding EPE and outcoupler can be expanded without limiting the size of the other. For example, referring to FIG. 7, the area of the EPE 714 can be expanded along the x-dimension and the y-dimension without interfering with the expansion of the outcoupler 716 along the x-dimension and the y-dimension since they are on different planes in the z-dimension. Thus, the FOV area of an eyewear display with waveguide 700 in a lens element can be expanded. This also applies to the waveguide configurations shown in FIGS. 8 and 9 as well.

Referring to FIG. 7, the waveguide 700 includes the first substrate 702 with the incoupler 712 and the EPE 714. As shown in FIG. 7, the EPE 714 expands light into/out of the Figure, i.e., along the y-direction. The waveguide 700 also includes the second substrate 704 with the outcoupler 716. The waveguide 700 further includes the set of facets 732, 734 to direct light from the first substrate 702 to the second substrate 704. The partition element illustrated in waveguide 700 is an air gap 722 (or other gas-filled gap) between the first substrate 702 and the second substrate 704. Thus, light propagates in the first substrate 702 via TIR with the external surface 742 of the first substrate 702 and the interface 744 between the first substrate 702 and the air gap 722. Similarly, light propagates in the second substrate 704 via TIR with the external surface 746 of the second substrate 704 and the interface 748 between the second substrate 704 and the air gap 722. Light propagating in the second substrate 704 is ejected from the second substrate 704 by the outcoupler 716.

Referring to FIG. 8, the waveguide 800 includes the first substrate 802 with the incoupler 812 and the EPE 814. As shown in FIG. 8, the EPE 814 expands light into/out of the Figure, i.e., along the y-direction. The waveguide 800 also includes the second substrate 804 with the outcoupler 816. The waveguide 800 further includes a set of facets 832, 834 to direct light from the first substrate 802 to the second substrate 804. The partition element illustrated in waveguide 800 is a low-refractive index material 822 between the first substrate 802 and the second substrate 804. The low-refractive index material 822 has a lower refractive index than each of the materials in the first substrate 802 and the second substrate 804. Thus, light propagates in the first substrate 802 via TIR with the external surface 842 of the first substrate 802 and the interface 844 between the first substrate 802 and the low-refractive index material 822. Similarly, light propagates in the second substrate 804 via TIR with the external surface 846 of the second substrate 804 and the interface 848 between the second substrate 704 and the low-refractive index material 822. Light propagating in the second substrate 804 is ejected from the second substrate 804 by the outcoupler 816.

Referring to FIG. 9, the waveguide 900 includes the first substrate 902 with the incoupler 912 and the EPE 914. As shown in FIG. 9, the EPE expands light into/out of the Figure, i.e., along the y-direction. The waveguide also includes the second substrate 904 with the outcoupler 916. The waveguide 900 further includes the set of facets 932, 934 to direct light from the first substrate 902 to the second substrate 904. The partition element illustrated in waveguide 800 is a polarization beam splitter (PBS) layer 922 between the first substrate 902 and the second substrate 904. The type of material for the PBS layer 922 is selected such that it reflects the type of polarization of the light propagating through the waveguide. For example, in some embodiments the display light emitted from an image source that is incoupled into the waveguide 900 is p-polarized. The PBS layer 922 is thus configured to reflect light with a p-polarization state. In another embodiment, the display light emitted from an image source that is incoupled into the waveguide 900 may be s-polarized. In this case, the PBS layer 922 is configured to reflect light with an s-polarization state. In any case, light propagates in the first substrate 902 via TIR with the external surface 942 of the first substrate 902 and reflecting off of the PBS layer 922 on the other side of the first substrate 902. Similarly, light propagates in the second substrate 904 via TIR with the external surface 946 of the second substrate 904 and reflecting off of the PBS layer 922 on the other side of the second substrate 904. Light propagating in the second substrate 904 is ejected from the second substrate 904 by the outcoupler 916.

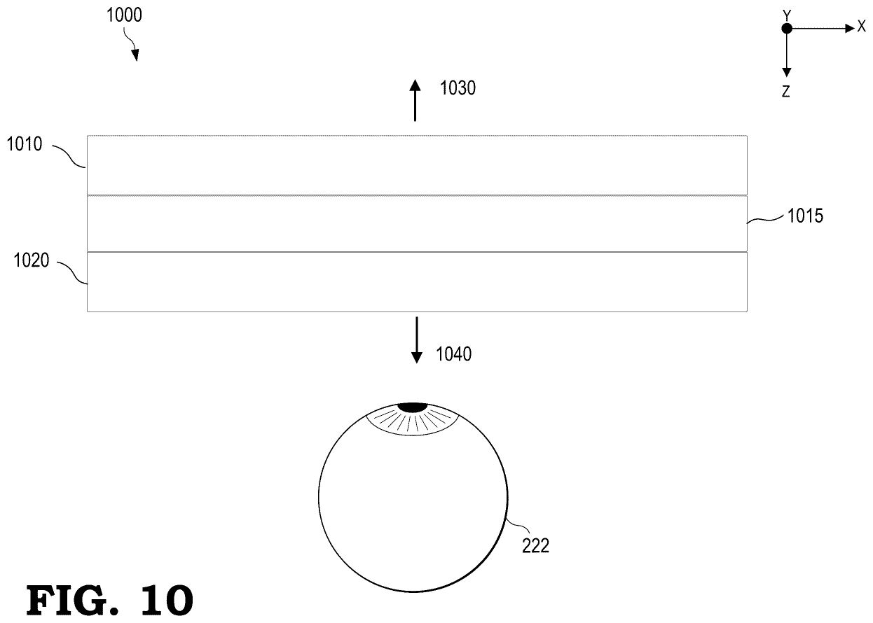

FIG. 10 shows an optical combiner 1000 in accordance with various embodiments. For example, optical combiner 1000 may correspond to one or both of lens elements 108, 110 in FIG. 1.

In some embodiments, the optical combiner 1000 combines environmental light (also referred to as ambient light) from a world-side 1030 and light emitted from an image source (such as by image source 202 in FIG. 2) such that the eye 222 of the user perceives images from the image source overlaid over the real-world environment. The optical combiner 1000 thus includes a first lens layer 1010 and a second lens layer 1020 with a waveguide 1015 disposed in between. In some embodiments, the first lens layer 1010 and the second lens layer 1020 are transparent or semi-transparent to allow ambient light from the environment to reach the eye 222 of the user. In some embodiments, the waveguide 1015 corresponds to any one of waveguide 600, waveguide 700, waveguide 800, or waveguide 900 illustrated in FIGS. 6-9, respectively. Thus, the waveguide 1015 of the optical combiner 1000 includes an expanded outcoupler, thereby allowing the optical combiner 1000 to display images over a larger area to be observed by the eye 222 of the user.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide comprising:
a first substrate comprising an exit pupil expander; and
a second substrate overlapping the first substrate, the second substrate comprising an outcoupler.

2. The waveguide of claim 1, further comprising one or more facets to direct light from the first substrate to the second substrate.

3. The waveguide of claim 2, wherein the one or more facets comprise reflective facets comprising a mirror coating.

4. The waveguide of claim 2, wherein the one or more facets comprise diffractive or holographic gratings.

5. The waveguide of claim 1, further comprising a partition element between the first substrate and the second substrate.

6. The waveguide of claim 5, wherein the partition element comprises a lower-refractive index than the first substrate and the second substrate.

7. The waveguide of claim 5, wherein the partition element comprises an airgap.

8. The waveguide of claim 5, wherein the partition element comprises a solid material.

9. The waveguide of claim 5, wherein the partition element comprises a polarization beam splitter.

10. The waveguide of claim 1, wherein the exit pupil expander expands light in a first direction and the outcoupler outcouples light from the waveguide in a second direction different from the first direction.

11. The waveguide of claim 10, wherein the first direction is orthogonal to the second direction.

12. The waveguide of claim 1, wherein the first substrate overlaps the second substrate when viewed from a direction at which the outcoupler outcouples light out of the waveguide.

13. An optical combiner comprising:
a first lens layer and a second lens layer; and
a waveguide disposed between the first lens layer and the second lens layer,
the waveguide comprising:
a first substrate comprising an exit pupil expander; and
a second substrate overlapping the first substrate, the second substrate comprising an outcoupler.

14. The optical combiner of claim 13, wherein the waveguide comprises one or more facets to direct light from the first substrate to the second substrate.

15. The waveguide of claim 13, wherein the waveguide comprises a partition element disposed between the first substrate and the second substrate.

16. The optical combiner of claim 15, wherein the partition element comprises a lower-refractive index than the first substrate and the second substrate.

17. The optical combiner of claim 13, wherein the partition element comprises a polarization beam splitter.

18. An eyewear display comprising:
one or more lenses comprising an optical combiner,
wherein the optical combiner comprises a waveguide comprising:
a first substrate comprising an exit pupil expander; and
a second substrate overlapping the first substrate, the second substrate comprising an outcoupler.

19. The eyewear display of claim 18, the optical combiner further comprising a first lens layer and a second lens layer, wherein the waveguide is disposed between the first lens layer and the second lens layer.

20. The eyewear display of claim 18, wherein the waveguide comprises:
one or more facets to direct light from the first substrate to the second substrate; and
a partition element between the first substrate and the second substrate.

21. The eyewear display of claim 18, wherein the partition element comprises a lower-refractive index than the first substrate and the second substrate.

22. The eyewear display of claim 18, further comprising a frame to hold the one or more lenses.
